(19) United States
(12) Patent Application Publication
(10) Pub. No.: US 2004/0057662 A1
(43) Pub. Date: Mar. 25, 2004

(54) Optically-connected system for exchanging data among industrial automation devices

(76) Inventor: Guiseppe Morfino, Pino Torinese (IT)

Correspondence Address: David A Farah, Sheldon & Mak, 9th Floor, 225 South Lake Avenue, Pasadena, CA, 91101, US

(21) Appl. No.: 10/432,125

(22) PCT Filed: Jun. 26, 2002
(86) PCT No.: PCT/IT02/00423

(51) Int. Cl. G02B 6/26; G02B 6/42

(52) U.S. Cl. 385/31

(57) ABSTRACT

An optically-connected system is disclosed for exchanging data among industrial automation devices, that is composed of a plurality of connection elements (7, 9′, 9″, . . . , 9^{N}), each one equipped with one or more pairs of optical transmitting (30, 32) and receiving (28, 34) means, placed on their main sides in an opposite way with respect to the previous pair, in such a way as to place on each main side of the connection elements (7, 9′, 9″, . . . , 9^{N}) one transmitting means (30, 32), one receiving means (28, 34) one transmitting means (30, 32) and so on, each one of the transmitting (30, 32) and receiving (28, 34) means being adapted to cooperate for exchanging data with a respective receiving (28, 34) and transmitting (30, 32) means of another adjacent of the connection elements (7, 9′, 9″, 9^{N}).

### CROSS-REFERENCE TO RELATED APPLICATION

This application claims priority from International Patent Application PCT/IT02/00423 entitled “Optically-Connected System for Exchanging Data Among Industrial Automation Devices,” filed Jun. 26, 2002, the contents of which are incorporated by reference herein in its entirety.

The present invention refers to an optically-connected system, in particular through optical rays with infrared frequency, for exchanging data among industrial automation devices.

Currently, in industrial automation applications, it is common to realise a plurality of connection elements (that contain input and output lines towards external devices such as sensors, etc.) placed one beside the other (for example on a DIN-type bar) and mutually connected and connected to a data collecting and ordering element (commonly known as “power terminal”), which, in turn, through a field bus, sends data, collected from different external devices, to an upstream numeric control. In order to realise the data exchange between connection elements and data collecting and ordering element, a serial connection is commonly provided that allows both the passage of different data, and the supply of various elements. The connection and data collecting and ordering elements are each contained inside a respective box, having various shapes and sizes, adapted to be assembled on bars or operatively installed in another way.

A system built in this way has many problems: first of all, when one of the connection elements fails, in some cases it is necessary to disassemble the whole row of elements, since such element cannot be individually removed; in other cases, if it is possible to remove the element shaped as a card from the box that contains it, its removal stops the serial connection line and therefore, if one has not a connection element to immediately replace it, such line is interrupted and then deactivated, with obvious disadvantages.

Moreover, the boxes containing the various elements are very often of a complicated configuration and therefore are of a very high cost for stamping them. Where the boxes are simpler as configuration, they are lacking many functionalities that current automations require.

Other problems of the above system are the presence of “physical” contacts that the various elements have in order to be mutually connected: such contacts are subjected to wear, dirt and other environmental conditions, such as for example electromagnetic disturbances, that damage their functionality, in turn damaging the other system connection elements.

Still more, the supply that it is possible to provide through the serial connection is relatively limited, allowing to mutually connect a maximum number of elements that is equal to 8 or 16 digital outputs each one at 250 mA. If the necessary connection elements are greater than this number, it is necessary to provide for a further system, serially connected to the previous one, with obvious problems of cost and connections.

Object of the present invention is solving the above prior-art problems by providing an optically-connected system that is simple to be realised, install, use and subject to maintenance, is of a reduced cost from the points of view both of manufacturing, and of use, and above all is much more efficient and reliable with respect to connections currently present on the market.

Another object of the present invention is providing an optically-connected system that allows quickly replacing faulty or unusable elements, that can moreover do without some elements in the series without anyway compromising the data exchange capability among the elements being present, and that is insensitive to electromagnetic disturbances on the lines, that are a frequent cause of errors in current connections. With an arrangement of this type, it is possible to group the various elements composing the series by families of use, simplifying and increasing the safety for maintenance people involved.

A further object of the present invention is providing an optically-connected system as mentioned above that is scarcely sensitive to influences from the surrounding environment, such as for example dirt, noises, vibrations, etc.

The above and other objects and advantages of the invention, as will appear from the following description, are obtained by an optically-connected system as claimed in claims 1 and 2. Preferred embodiments and non-trivial variations of the present invention are claimed in the dependent claims.

The present invention will be better described by some preferred embodiments thereof, given as a non-limiting example, with reference to the enclosed drawings, in which:

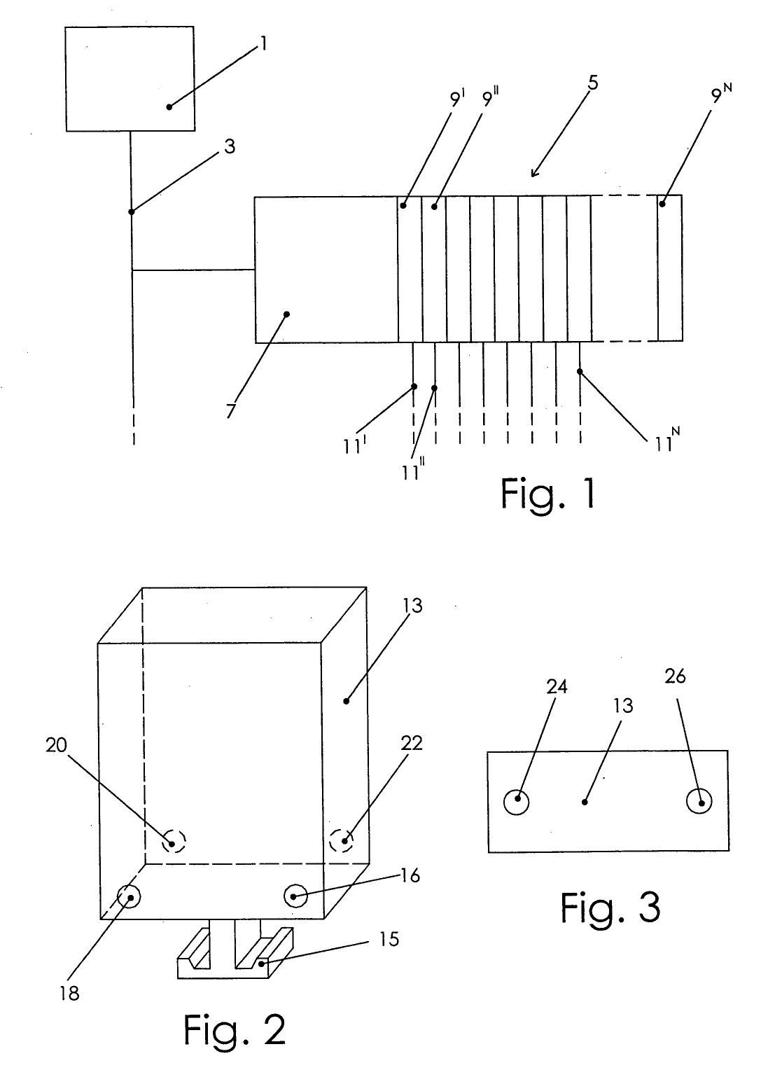

FIG. 1 is a schematic block view of a configuration of industrial automation elements to which the optically-connected system of the present invention can be applied;

FIG. 2 is a schematic perspective view of an industrial automation box that can be used with the present invention;

FIG. 3 is a bottom view of the box in FIG. 2;

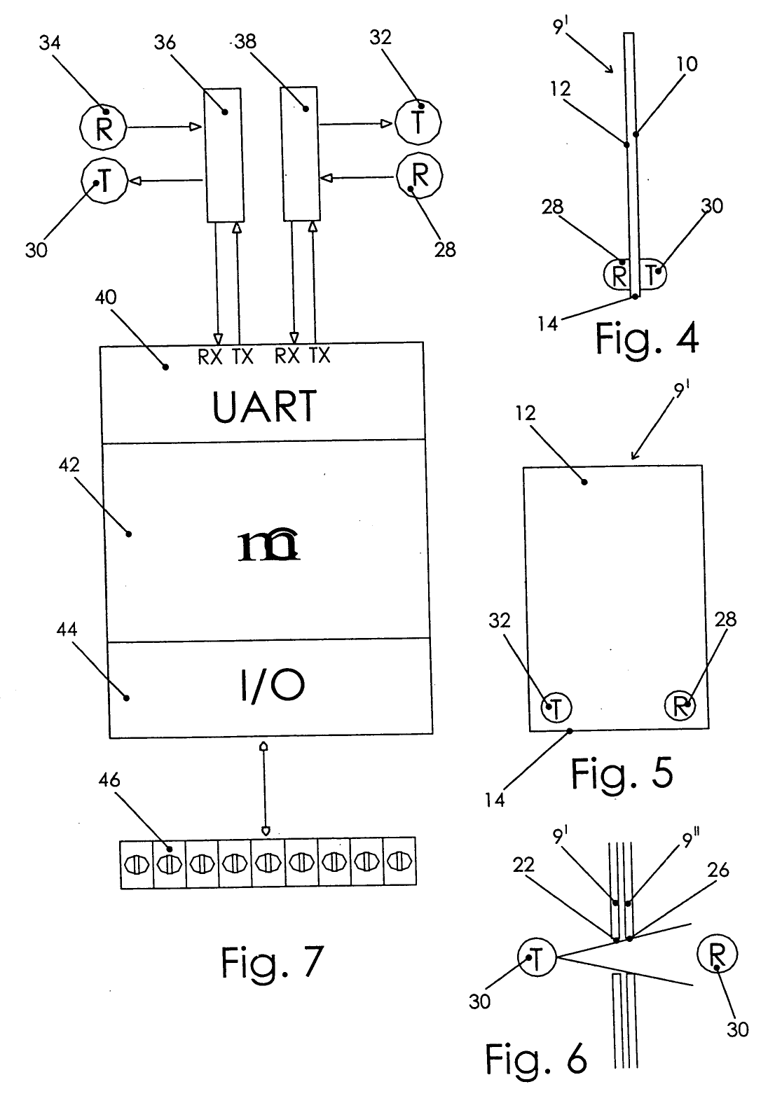

FIG. 4 is a schematic side view of a plate that points out the optically-connected system of the invention applied thereto;

FIG. 5 is a front view of the plate in FIG. 4;

FIG. 6 is a schematic operating view of the optically-connected system of the invention; and

FIG. 7 is a schematic block diagram of the main components necessary for implementing the optically-connected system of the present invention.

With reference to the Figures, non-limiting examples of embodiments of the optically-connected system of the present invention are shown. The device will be described hereinbelow by applying it to the field of industrial automation in general, but it is evident that it can find a valid and efficient application to any field in which it is necessary to perform an efficient data exchange between mutually connectable devices that are preferably adjacent and use a supply and data exchange bus.

A first preferred embodiment of the present invention (shown in the drawings only in a general form) provides for an optically-connected system for exchanging data among industrial automation devices, composed of a plurality of connection elements 7, 9′, 9″, . . . , 9^{N}. Each one of such connection elements 7, 9′, 9″, . . . , 9^{N} is equipped with one pair of optical transmitting 30, 32 and receiving 28, 34 means: such pair is composed of one optical transmitting means 30, 32 placed on the main side 10 of each one of the connection elements 7, 9′, 9″, 9^{N} and of one optical receiving means 28, 34 placed on an opposed main side 12 of each one of the connection elements 7, 9′, 9″, . . . , 9^{N}. Moreover, each one of the transmitting 30, 32 and receiving 28, 34 means is adapted to cooperate for exchanging data with a respective receiving 28, 34 and transmitting 30, 32 means of another adjacent of the connection elements 7, 9′, 9″, . . . , 9^{N} According to another preferred embodiment shown in the Figures, the optically-connected system for exchanging data among industrial automation devices of the present invention also substantially comprises a plurality of connection elements 7, 9′, 9″, . . . , 9^{N} each one of said which is equipped with at least two pairs of optical transmitting 30, 32 and receiving 28, 34 means. Each pair is composed of one optical transmitting means 30, 32 placed on the main side 10 of each one of the connection elements 7, 9′, 9″, . . . , 9^{N} and of one optical receiving means 28, 34 placed on an opposed main side 12 of each one of the connection elements 7, 9′, 9″, . . . , 9^{N}; moreover, in order to always guarantee the operating functionality of the connection elements 7, 9′, 9″, . . . , 9^{N} independently from the orientation with which they are assembled (form example on a DIN-type bar), each pair of optical transmitting 30, 32 and receiving 28, 34 means is further placed on the main sides 10, 12 of the connection elements 7, 9′, 9″, . . . , 9^{N} in an opposite way with respect to the previous pair in such a way as to place on each main side 10, 12 of the connection elements 7, 9′, 9″, . . . , 9^{N} one transmitting means 30, 32 followed by one receiving means 28, 34 (as can be better seen in FIG. 5), eventually followed by one transmitting means 30, 32 (not shown) and so on. Also in this case, each one of the transmitting 30, 32 and receiving 28, 34 means is adapted to cooperate for exchanging data with a respective receiving 28, 34 and transmitting 30, 32 means of another adjacent of the connection elements 7, 9′, 9″, . . . , 9^{N}.

In order to allow installation and connection of a higher number of connection elements 7, 9′, 9″, . . . , 9^{N}, according to application requirements, at least one of the connection elements 7, 9′, 9″, . . . , 9^{N} can further be equipped, on one of its minor sides 14 perpendicular to the sides 10, 12 on which the transmitting 30, 32 and receiving 28, 34 means are placed, with at least one further pair of transmitting 30, 32 and receiving 28, 34 means (not shown). In this case, two adjacent rows of connection elements 7, 9′, 9″, . . . , 9^{N}; can be installed and data are transmitted and received not only along the two rows, but also between one row and the other, with an optical “perpendicular” connection between an element of a row and the corresponding element below in the other row.

As known, the connection elements 7, 9′, 9″, . . . , 9^{N} are placed inside respective boxes 13 for industrial automation: in order to allow their use with the present invention, however, it is not necessary that such boxes 13 are of a particularly complicated and costly shape or configuration; instead, boxes 13 are chosen that are as inexpensive as possible. The boxes 13, like the one schematically shown in FIG. 2, are equipped with means 15 for the connection to bars (for example of the DIN type). In order to be able to use such boxes 13 with the present invention, it is enough to drill, in each one of them, holes 16, 18, 20, 22 obtained next to the transmitting 30, 32 and receiving 28, 34 means in order to allow their mutual operability. Obviously, the boxes 13 for the connection elements 7, 9′, 9″, . . . , 9^{N} adapted to also perform the “perpendicular” connection, will also have holes 24, 26 obtained next to the further pair of transmitting 30, 32 and receiving 28, 34 means being present on the side 14.

Preferably, the optical transmitting 30, 32 and receiving 28, 34 means are composed of transmitters and receivers of optical rays at infrared frequency, particularly, but not in a limiting way, operating according to the IrDa protocol.

With this type of optical components, an operating circuit can be realised, schematically shown in FIG. 7, which provides that each pair of transmitters 30, 32 and receivers 28, 34 is connected to a respective encoder/decoder 36, 38 in turn connected to control and management means 40, 42 (commonly a UART-type of card 40 and a microprocessor 42). Such control and management means 40, 42 are connected, through an I/O interface 44, to a terminal board 46 for supply and signal input/output from external industrial automation devices (not shown).

Alternatively, obviously, the optical transmitting 30, 32 and receiving 28, 34 means can be composed of transmitters and receivers of optical rays with laser rays, at microwave frequency, or other types of equivalent optical means, and even using visible light.

In order to complete the operating connections of the system of the invention, the supply to each one of the connection elements 7, 9′, 9″, . . . , 9^{N} can be provided separately with respect to the optically-connected system, for example by serial connections through small cables, or using detachable connection terminal boards, in order to facilitate supply disconnection and reconnection operations when replacing or maintaining the connection elements 7, 9′, 9″, . . . , 9^{N} and/or the boxes 13.

Further in a known way, as shown in FIG. 1, the connection elements 7, 9′, 9″, . . . , 9^{N} are composed of a plurality of data input and output elements 9′, 9″, . . . , 9^{N} respectively connected (through digital inputs or outputs 11′, 11″, . . . , 11^{N} that can be 2, 4, 8 and like numbers) to external industrial automation devices (not shown) and of a data collecting and queuing element 7 (“power terminal”) operatively connected to the data input and output elements 9′, 9″, . . . , 9^{N}: such element 7 is connected, through a field bus 3, to an upstream numeric control 1 for managing data.

With the above-described system it is therefore possible to obtain the following advantages:

1. If a module 9′, 9″, . . . , 9^{N} is removed, the system goes on operating.

2. If due to a connection error, during the installation phase, high voltage is provided to a module 9′, 9″, . . . , 9^{N}, this one is damaged, but the other ones, being galvanically insulated, remain operating.

3. Not having the constraint of arranging the modules 9′, 9″, . . . , 9^{N} one beside the other, they can be separated in order to divide them logically depending on the type of treated signals or their functionality, with following simplifications for maintenance personnel and responsible operators.

1. Optically-connected system for exchanging data among industrial automation devices, characterised in that it is composed of a plurality of connection elements (7, 9′, 9″, . . . , 9^{N}), each one of said connection elements (7, 9′, 9″, . . . , 9^{N}) being equipped with one pair of optical transmitting (30, 32) and receiving (28, 34) means, said pair being composed of one optical transmitting means (30, 32) placed on a main side (10) of each one of said connection elements (7, 9′, 9″, . . . , 9^{N}) and of one optical receiving means (28, 34) placed on an opposed main side (12) of each one of said connection elements (7, 9′, 9″, . . . , 9^{N}), each one of said transmitting (30, 32) and receiving (28, 34) means being adapted to cooperate for exchanging data with a respective receiving (28, 34) and transmitting (30, 32) means of another adjacent of said connection elements (7, 9′, 9″, . . . , 9^{N})

2. Optically-connected system for exchanging data among industrial automation devices, characterised in that it is composed of a plurality of connection elements (7, 9′, 9″, . . . , 9^{N}), each one of said connection elements (7, 9′, 9″, . . . , 9^{N}) being equipped with at least two pairs of optical transmitting (30, 32) and receiving (28, 34) means, each pair being composed of one optical transmitting means (30, 32) placed on a main side (10) of each one of said connection elements (7, 9′, 9″, . . . , 9^{N}) and of one optical receiving means (28, 34) placed on an opposed main side (12) of each one of said connection elements (7, 9′, 9″, . . . , 9^{N}), each pair of optical transmitting (30, 32) and receiving (28, 34) means being further placed on said main sides (10, 12) of said connection elements (7, 9′, 9″, . . . , 9^{N}) in an opposite way with respect to the previous pair in such a way as to place on each main side (10, 12) of said connection elements (7, 9′, 9″, . . . , 9^{N}) one transmitting means (30, 32) followed by one receiving means (28, 34) eventually followed by one transmitting means (30, 32) and so on, each one of said transmitting (30, 32) and receiving (28, 34) means being adapted to cooperate for exchanging data with a respective receiving (28, 34) and transmitting (30, 32) means of another adjacent of said connection elements (7, 9′, 9″, . . . , 9^{N}).

3. Optically-connected system according to claim 1 or 2, characterised in that at least one of said connection elements (7, 9′, 9″, . . . , 9^{N}) is equipped on one of its minor sides (14) perpendicular to the sides (10, 12) on which the transmitting (30, 32) and receiving (28, 34) means are placed, with at least one further pair of transmitting (30, 32) and receiving (28, 34) means.

4. Optically-connected system according to claim 1 or 2, characterised in that said connection elements (7, 9′, 9″, . . . , 9^{N}) are placed inside respective boxes (13) for industrial automation, each one of said boxes (13) being equipped with holes (16, 18, 20, 22) obtained next to said transmitting (30, 32) and receiving (28, 34) means in order to allow their mutual operability.

5. Optically-connected system according to claim 3, characterised in that said connection elements (7, 9′, 9″, . . . , 9^{N}) are placed inside respective boxes (13) for industrial automation, each one of said boxes (13) being equipped with holes (16, 18, 20, 22) obtained next to said transmitting (30, 32) and receiving (28, 34) means in order to allow their mutual operability and with holes (24, 26) obtained next to said at least one further pair of transmitting (30, 32) and receiving (28, 34) means in order to allow their operability.

6. Optically-connected system according to claim 1 or 2, characterised in that said optical transmitting (30, 32) and receiving (28, 34) means are composed of transmitters and receivers of optical rays at infrared frequency.

7. Optically-connected system according to claim 6, characterised in that said transmitters and receivers of optical rays at infrared frequency operate according to the IrDa protocol.

8. Optically-connected system according to claim 6 or 7, characterised in that each pair of said transmitters (30, 32) and receivers (28, 34) is connected to a respective encoder/decoder (36, 38) in turn connected to control and management means (40, 42), said control and management means (40, 42) being connected, through an I/O interface (44), to a terminal board (46) for supply and signal input/output from external industrial automation devices.

9. Optically-connected system according to claim 8, characterised in that said control and management means (40, 42) are composed of a UART-type element (40) and a microprocessor (42).

10. Optically-connected system according to claim 1 or 2, characterised in that said optical transmitting (30, 32) and receiving (28, 34) means are composed of transmitters and receivers of optical rays with laser rays.

11. Optically-connected system according to claim 1 or 2, characterised in that said optical transmitting (30, 32) and receiving (28, 34) means are composed of transmitters and receivers of optical rays on a microwave frequency or through visible light.

12. Optically-connected system according to claim 1 or 2, characterised in that a supply to each one of said connection elements (7, 9′, 9″, . . . , 9^{N}) is provided separately with respect to said optically-connected system.

13. Optically-connected system according to claim 12, characterised in that the supply is provided by serial connections through small cables.

14. Optically-connected system according to claim 12, characterised in that the supply is provided by detachable connection terminal boards.

15. Optically-connected system according to claim 1 or 2, characterised in that said connection elements (7, 9′, 9″, . . . , 9^{N}) are composed of a plurality of data input and output elements (9′, 9″, . . . , 9^{N}) respectively connected (through 11′, 11″, . . . , 11^{N}) to industrial automation devices and of a data collecting and queuing element (7) operatively connected to said data input and output elements (9′, 9″, . . . , 9^{N}), said element (7) being connected, through a field bus (3), to a numeric control (1) for managing data.
